(19) United States
(12) Patent Application Publication
(10) Pub. No.: US 2017/0281991 A1
(43) Pub. Date: Oct. 5, 2017

(54) END OF SERVICE LIFE INDICATOR FOR DISPOSAL MASK

(71) Applicants: Li WANG, Morristown, NJ (US); Xiang ZHU, Morristown, NJ (US); Yuzheng LU, Morristown, NJ (US); Honeywell International Inc., Morris Plains, NJ (US)

(72) Inventors: Li Wang, Shanghai (CN); Xiang Zhu, Shanghai (CN); Yuzheng Lu, Shanghai (CN)

(21) Appl. No.: 15/508,860

(22) PCT Filed: Sep. 5, 2014
(86) PCT No.: PCT/CN2014/085977

§ 371 Date: Mar. 3, 2017

(51) Int. Cl. A62B 9/00; A41D 13/11

(52) U.S. Cl. CPC A62B 9/006; A41D 13/1138; A41D 2500/30

(57) ABSTRACT

Embodiments relate generally to methods and systems for detecting and indicating end-of-service-life in disposable filtration masks. Applicant has proposed incorporating end-of-service-life indicators comprising color changing chemicals into the mask. The indicating chemicals may be incorporated into the nonwoven fabric material of the mask, or may be attached to the nonwoven material of the mask, such as by dipping, spraying, or adhering. The color change of the indicating chemicals may indicate to a user that the use life of the mask has been depleted.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Personal protection equipment (PPE), specifically disposable masks, may be required to conform to certain regulations during design and manufacture. The user's ability and ease of breathing while wearing the mask may be considered, as well as the fit and the comfort of the user who may wear the mask. PPE, such as disposable masks or reusable cartridges, may comprise filtration media, which may be made of melt-blown fibers and/or micro glass material. Filtration by a mask is accomplished when particles in the air are trapped in the matrix of the fibers contained in the filtration media of the mask.

### SUMMARY

Aspects of the disclosure may include embodiments of a disposable mask comprising: an interior surface, located proximate to a user's face; an exterior surface, located opposite to the interior surface; a filtering nonwoven fabric material; and an end of service life indicator comprising one or more indicator chemicals incorporated into the nonwoven fabric material, wherein: the indicator chemicals change color to indicate end of service life of the mask; and the indicator chemicals react with a user's exhaled breath to change color.

In some embodiments, the indicator chemicals may be located on a strip and the strip may be incorporated into the nonwoven fabric material by attaching to the interior surface of the mask. In some embodiments, the indicator chemicals may be incorporated into the nonwoven fabric material by dipping the nonwoven fabric material into the indicator chemicals. In some embodiments, the indicator chemicals may be incorporated into the nonwoven fabric material by spraying the indicator chemicals onto at least one surface of the mask. In some embodiments, the indicator chemicals may be incorporated into the nonwoven fabric material by adding fibers of the indicator chemicals into the forming process of the nonwoven fabric material. In some embodiments, the forming process of the nonwoven fabric material may comprise one of: spinbonding, electrospinning, or meltblowing. In some embodiments, the indicator chemicals may comprise at least one of: a pH indicator, litmus, bromophenol blue, bromothymol blue, methyl violet, cresol red, thymol blue, methyl yellow, methyl red, natural red, methyl orange, bromocresol green, phenolphthalein, chlorophenol red, and allochroic silica gel. In some embodiments, the indicator chemicals may react with carbon dioxide exhaled in a user's breath. In some embodiments, the indicator chemicals may react with water exhaled in a user's breath. In some embodiments, the indicator chemicals may react with water and carbon dioxide exhaled in a user's breath. In some embodiments, the mask may further comprise a reference color strip attached to the mask, wherein end of service life is indicated when the color change of the indicator chemicals matches the reference color strip.

Additional aspects of the disclosure may include embodiments of a disposable mask comprising: a filtering nonwoven fabric material; and an end of service life indicator comprising one or more indicator chemicals incorporated into the nonwoven fabric material, wherein: the indicator chemicals change color to indicate end of service life of the mask; the indicator chemicals react with water and carbon dioxide exhaled in a user's breath; and the indicator chemicals comprise at least one of: a pH indicator, litmus, bromophenol blue, bromothymol blue, methyl violet, cresol red, thymol blue, methyl yellow, methyl red, natural red, methyl orange, bromocresol green, phenolphthalein, chlorophenol red, and allochroic silica gel.

In some embodiments, the indicator chemicals may be located on a strip and the strip is incorporated into the nonwoven fabric material by attaching to the interior surface of the mask. In some embodiments, the indicator chemicals may be incorporated into the nonwoven fabric material by applying the indicator chemicals to the surface of the already formed nonwoven fabric material. In some embodiments, the indicator chemicals may be incorporated into the nonwoven fabric material by adding fibers of the indicator chemicals into the forming process of the nonwoven fabric material. In some embodiments, the forming process of the nonwoven fabric material may comprise one of: spinbonding, electrospinning, or meltblowing.

Other aspects of the disclosure may include embodiments of a method for determining end of service life for a disposable face mask, the method comprising: determining a correlation between the exhalation from a user and the use life of the mask; incorporating color changing indicator chemicals into the disposable face mask; determining a color change standard for the color changing indicator chemicals at the end of the use life of the mask; and monitoring the reaction of the color changing indicator chemicals with one of water and carbon dioxide from a user's exhalation to determine end of service life.

In some embodiments, the method may further comprise installing a color reference strip onto the disposable masks, wherein the color reference strip may comprise the determined color change standard. In some embodiments, the color changing indicator chemicals may comprise one or more of: a pH indicator, litmus, bromophenol blue, bromothymol blue, methyl violet, cresol red, thymol blue, methyl yellow, methyl red, natural red, methyl orange, bromocresol green, phenolphthalein, chlorophenol red, and allochroic silica gel. In some embodiments, incorporating color changing indicator chemicals into the disposable face mask may comprise adding fibers of the indicator chemicals into the forming process of the mask.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates an exemplary disposable face mask;

FIG. 2 illustrates an embodiment of a disposable mask comprising an end of service life indicator;

FIG. 3 illustrates another embodiment of a disposable mask comprising an end of service life indicator; and

FIG. 4 illustrates a method for determining end of service life for a disposable face mask.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Embodiments relate generally to disposable filtration masks comprising end-of-service-life indicators. Typical disposable and/or reusable filters for respirators may be constructed of nonwoven fabric materials, and maybe operable to filter particles in the air moving both directions during inhalation and exhalation by a user or wearer. After a certain wear time or use life, the filtration capabilities of the disposable mask may be depleted, possibly due to accumulation of filtered particles in the nonwoven fabric.

Applicant has proposed methods for detecting and indicating end-of-service-life for disposable masks by incorporating color changing chemicals into the mask. The indicating chemicals may be incorporated into the nonwoven fabric material of the mask, or may be attached to the nonwoven material of the mask, such as by dipping, spraying, or adhering. The color change of the indicating chemicals may indicate to a user that the use life of the mask has been depleted.

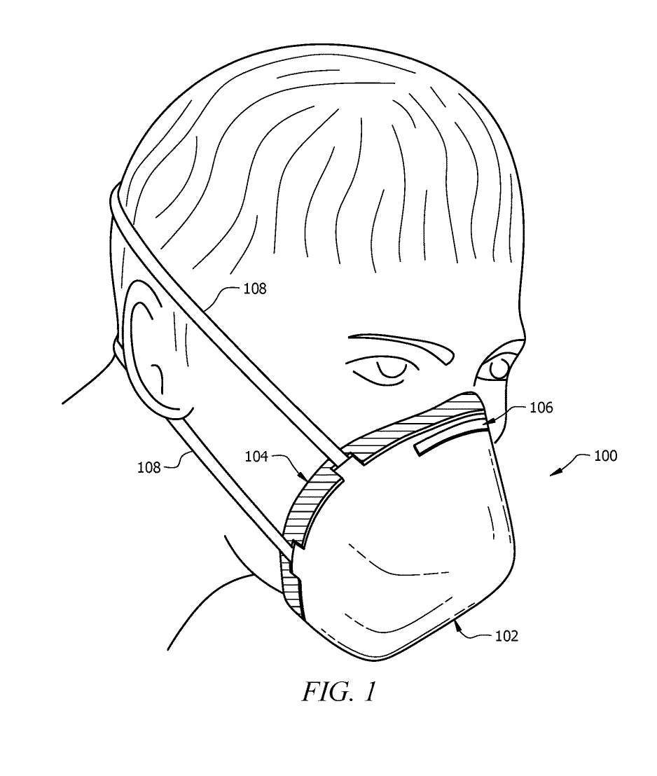

Referring to FIG. 1, an exemplary face mask 100 is shown. The mask 100 may comprise an exterior surface 102 and an interior surface 104. In some embodiments, the mask 100 may include elements for holding the mask to a user's face, such as straps 108 and a nose clip 106. In some embodiments, the mask may comprise a nonwoven fabric material.

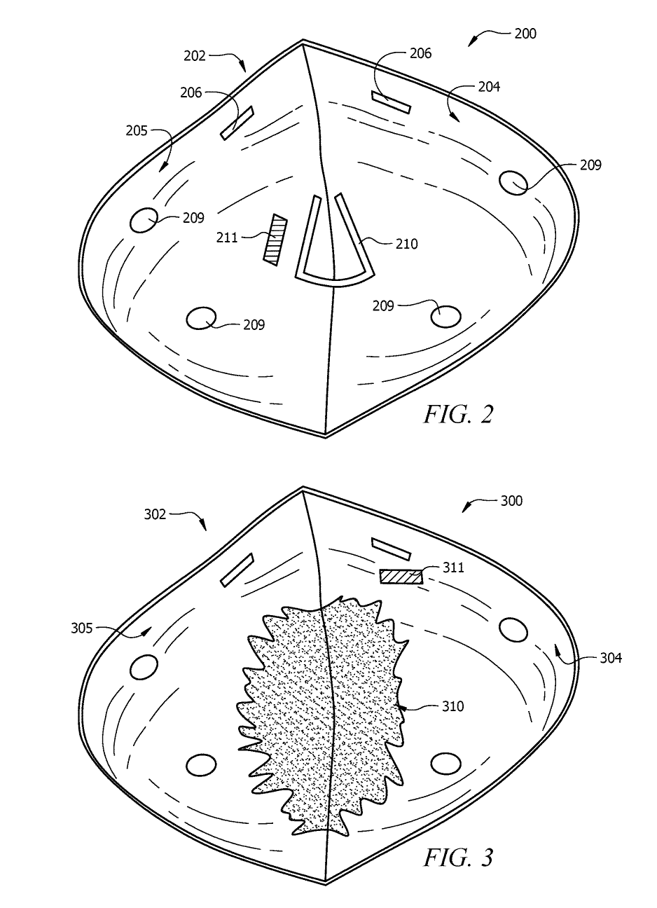

FIG. 2 illustrates an exemplary embodiment of a face mask 200 comprising an end-of-service-life indicator (ESLI) 210. The mask 200 may comprise a nonwoven fabric material 205. In the embodiment of FIG. 2, the ESLI 210 may be located on the interior surface 204 of the mask 200. In some embodiments, the ESLI 210 may indicate end-of-service-life of the mask 200 by reacting with a user's exhaled breath, for example the water and/or carbon dioxide exhaled by a user. Although the mask 200 may be used to filter harmful chemicals from the air to protect the user, the amount of carbon dioxide and/or water exhaled by the user may be correlated to the use life of the mask. For example, the amount of exhaled breath may be related to the time the mask has been worn by the user, and thereby the time the mask has been used for filtering particles form the air. Therefore, the carbon dioxide and/or water may be measured by the ESLI 210 by reaction with indicator chemicals, which may change color for example, to indicate the end-of-service-life for the mask 200. In some embodiments, the determined use life of a disposable mask 200 may be customized based on the specific needs for user, including what particles will be filtered by the mask, the location of the user when wearing the mask, etc.

In some embodiments, the ESLI 210 may comprise strips containing indicator chemicals, wherein the strips may be attached to the interior surface 204 of the mask 200. In some embodiments, the strips of the ESLI 210 may comprise a rectangular shape, as shown in FIG. 2, while in other embodiments the ELSI 210 may comprise strips of any shape (such as circular, rounded, rectangular, square, semi-circular, etc.) that may be operable to attach to the interior surface 204 of the mask 200. Additionally, the strips of the ESLI 210 of FIG. 2 may comprise a small shape relative to the size of the mask 200, but any size strip that accomplishes the same purpose may be used for the ESLI 210. The strips may be attached by stapling, pinning, adhering, gluing, or any other attachment method. In some embodiments, the ESLI 210 may comprise litmus or other pH indicators, such as bromophenol blue, bromothymol blue, methyl violet, cresol red, thymol blue, methyl yellow, methyl red, natural red, methyl orange, bromocresol green, phenolphthalein, and chlorophenol red, operable to indicate the pH of the air flowing through the mask 200 from the exhalations of the user. The color change of the pH indicators may be affected by the amount of carbon dioxide and/or water in the air flowing from the interior surface 204 to the exterior surface 202 of the mask. In some embodiments, the ESLI 210 may comprise other chemicals, including silica compounds such as allochroic silica gel. In some embodiments, a reference color strip 211 may be provided, possibly attached to the mask, to indicate the color that the ESLI 210 will reach at the end-of-service-life. In some embodiments, the mask 200 may comprise elements 209 for attaching straps (similar to straps 108) as well as elements 206 for attaching a nose strip (similar to nose strip 106).

FIG. 3 illustrates another exemplary embodiment of a disposable face mask 300 comprising a color changing ESLI 310. The mask 300 may comprise a nonwoven fabric material 305. In the embodiment of FIG. 3, the indicator chemicals of the ESLI 310 may be incorporated into the material of the mask 300. This may be accomplished by spraying the indicator chemicals onto at least one of the interior surface 304 or exterior surface 302 of the mask 300 or dipping the mask 300 into the indicator chemicals. In some embodiments, the indicator chemicals may be incorporated into the mask material during the formation of the mask material, such as by spinbonding, electrospinning, or meltblowing, for example. The indicator chemicals may be added to the nonwoven material when the fibers of the material are formed. In some embodiments, a reference color strip 311 may be provided, possibly attached to the mask, to indicate the color that the ESLI 310 will reach at the end-of-service-life.

In some embodiments, the indicator chemicals of the ESLI 310 may be located on only a portion of the interior surface 304 and/or exterior surface 302. In some embodiments, the indicator chemicals may cover at least a fourth of the surface area of the mask 300.

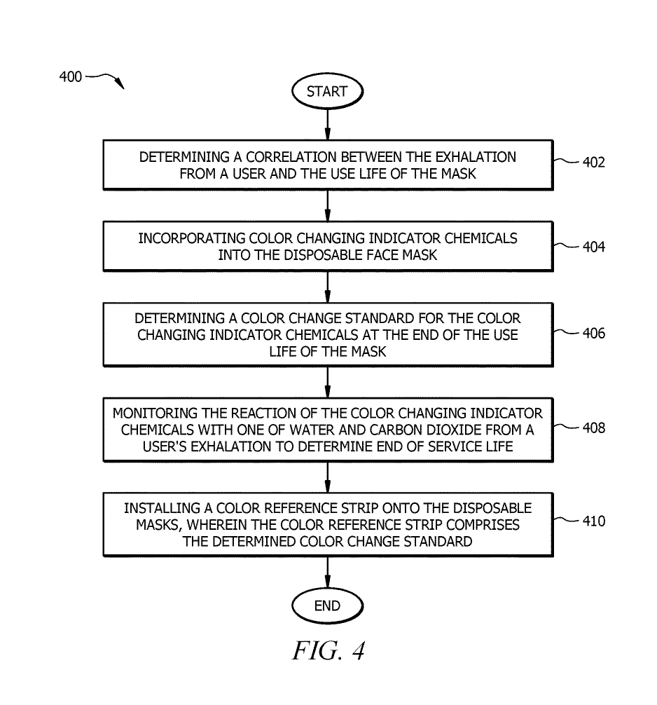

Referring now to FIG. 4, some embodiments of the disclosure may include a method 400 for determining the end-of-service-life for a disposable face mask. At step 402, a correlation may be determined between the exhalation from a user and the use life of the mask. At step 404, color changing indicator chemicals may be incorporate into the disposable face mask. At step 406, a color change standard may be determined for the color changing indicator chemicals at the end of the use life of the mask. At step 408, the reaction of the color changing indicator chemicals with one of water and carbon dioxide from a user's exhalation may be monitored to determine end of service life. In some embodiments, at step 410, a color reference strip may be installed onto the disposable masks, wherein the color reference strip may comprise the determined color change standard. In some embodiments, the color changing indicator chemicals may comprise one or more of: a pH indicator, litmus, bromophenol blue, bromothymol blue, methyl violet, cresol red, thymol blue, methyl yellow, methyl red, natural red, methyl orange, bromocresol green, phenolphthalein, chlorophenol red, and allochroic silica gel. In some embodiments, incorporating color changing indicator chemicals into the disposable face mask may comprise adding fibers of the indicator chemicals into the forming process of the mask.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A disposable particulate filtration mask comprising:
an interior surface, located proximate to a user's face;
an exterior surface, located opposite to the interior surface;
a filtering nonwoven fabric material; and
an end of service life indicator comprising one or more indicator chemicals incorporated into the nonwoven fabric material (210), wherein:
the indicator chemicals change color in a way correlating to an indication of end of service life of the particulate filtering nonwoven fabric material; and
the indicator chemicals react with a user's exhaled breath to change color.

2. The method of claim 14, wherein the indicator chemicals are located on a strip and the strip is incorporated into a nonwoven fabric material by attaching to the interior surface of the mask.

3. The method of claim 14, wherein the indicator chemicals are incorporated into a nonwoven fabric material by dipping the nonwoven fabric material into the indicator chemicals.

4. (canceled)

5. The method of claim 14, wherein the indicator chemicals are incorporated into a nonwoven fabric material by adding fibers of the indicator chemicals into the forming process of the nonwoven fabric material.

6. The mask of claim 1, wherein the indicator chemicals comprise at least one of: a pH indicator, litmus, methyl red, methyl orange, bromocresol green, phenol, allochroic silica gel.

7. The mask of claim 1, wherein the indicator chemicals react with carbon dioxide exhaled in a user's breath, and end of service life indicator is configured to correlate carbon dioxide to use life of the mask.

8. The mask of claim 1, wherein the indicator chemicals react with water exhaled in a user's breath, and end of service life indicator is configured to correlate water to use life of the mask.

9. The mask of claim 1, further comprising a reference color strip attached to the mask, wherein end of service life for the particulate filtering nonwoven fabric material is indicated when the color change of the indicator chemicals matches the reference color strip.

10. (canceled)

11. (canceled)

12. The method of claim 1, wherein the indicator chemicals are incorporated into the nonwoven fabric material by applying the indicator chemicals to a surface of an already formed nonwoven fabric material.

13. (canceled)

14. A method for determining end of service life for a disposable particulate filtration face mask, the method comprising:
determining a correlation between the exhalation from a user and the use life of the mask;
incorporating color changing indicator chemicals into the disposable face mask;
determining a color change standard for the color changing indicator chemicals at the end of the use life of the mask; and
monitoring the reaction of the color changing indicator chemicals with one or more of water and carbon dioxide from a user's exhalation to determine end of service life.

15. The method of claim 14 further comprising installing a color reference strip onto the disposable masks, wherein the color reference strip comprises the determined color change standard.

16. The method of claim 14 wherein determining correlation between the exhalation from a user and the use life of the mask comprises correlating the amount of one or more of carbon dioxide and water reacting with the indictor chemicals with exhalation.

17. The method of claim 15, wherein monitoring the reaction of the color changing indicator chemicals with one or more of water and carbon dioxide from a user's exhalation to determine end of service life comprises comparing the color changing indicator chemicals to the color reference strip.

18. The method of claim 1 wherein the particles filtered by the mask are harmful chemicals.

19. The method of claim 14 wherein incorporating color changing indicator chemicals into the disposable face mask comprises adding color changing indicator chemicals to nonwoven fabric particulate filtration material of the disposable face mask.

20. The method of claim 16 further comprising correlating exhalation breaths from the user to accumulation of filtered particles on a filtering nonwoven fabric material of the mask, such that the indicator chemicals are indirectly correlated to end of use life of the mask due to accumulation of filtered particles.

21. The method of claim 20 wherein the correlation is based on the specific particles to be filtered by the mask.

22. The method of claim 12 wherein the indicator chemicals are applied to the exterior surface of the nonwoven fabric material.

23. The method of claim 12 wherein the indicator chemicals are applied to the interior surface of the nonwoven fabric material.

24. The method of claim 14 further comprising adding a plurality of different indicator chemicals to the mask, each of which is configured to react with a different particle; and determining a color change standard for each of the plurality of color changing indicator chemicals for indicating the end of the use life of the mask based on accumulation of the related particle.
